(19) United States
(12) Patent Application Publication
(10) Pub. No.: US 2011/0273395 A1
(43) Pub. Date: Nov. 10, 2011

(54) TOUCH SCREEN AND METHOD FOR CONTROLLING THE SAME

(75) Inventor: Il Kwon CHUNG, Gyunggi-do (KR)

(73) Assignee: SAMSUNG ELECTRO-MECHANICS CO., LTD., Gyunggi-do (KR)

(21) Appl. No.: 12/843,717

(22) Filed: Jul. 26, 2010

(30) Foreign Application Priority Data
May 6, 2010 (KR) 10-2010-0042553

(51) Int. Cl. G06F 3/044

(52) U.S. Cl. 345/174

(57) ABSTRACT

Disclosed herein are a touch screen and a method for controlling the same. The touch screen includes: two sheets of transparent substrates; transparent electrodes each formed on one surface of the two sheets of transparent substrates and sensing the change in capacitance at the time of a user input; and a spacer bonding one surface of the two sheets of transparent substrates to each other, wherein the coordinates of the input are measured by detecting the change in capacitance sensed by the transparent electrodes and lowering sensitivity when the capacitance becomes larger. The embodiments provide the touch screen that can accurately measure the coordinates by controlling the sensitivity based on the change in capacitance, and the method for controlling the same.

### CROSS REFERENCE TO RELATED APPLICATION

This application claims the benefit of Korean Patent Application No. 10-2010-0042553, filed on May 6, 2010, entitled “Touch screen and method for controlling the same”, which is hereby incorporated by reference in its entirety into this application.

### BACKGROUND OF THE INVENTION

1. Technical Field

The present invention relates to a touch screen and a method for controlling the same.

2. Description of the Related Art

With the continuous development in the electronic technology and the information technology fields, the relative importance of electronic devices is constantly increasing in everyday life, including work environment. In particular, as electronic technology continuously develops, personal computers and portable transmitters etc. process texts and graphics, using a variety of input devices, such as a keyboard, a mouse, a digitizer, etc. These input devices, however, have been developed in consideration of the expanding usage of personal computers, such that they are difficult to be applied to portable devices that are recently reduced in size and thickness. Therefore, touch screens are on the rise as an input device appropriate for the portable devices.

Touch screens, devices generally installed in display devices to detect positions on the screen touched by a user and control electronic devices, using information on the detected contact position as input information, in addition to controlling the picture of the display, have various advantages of being simply operated with little malfunction in a small space and very compatible with IT devices.

Meanwhile, the touch screen is classifiable as a resistive type, a capacitive type, an electromagnetic type, a surface acoustic wave (SAW) type, an infrared type, and so on. Among others, resistive and capacitive types are prevalently used in consideration of the functions and economics.

The resistive touch screen is a method to measure the change in resistance generated as indium tin oxide (ITO) electrodes formed on two sheets of transparent substrates contact each other, when there is a user input. Therefore, the ITO electrode formed on the upper portion should be continuously bent toward the ITO electrode formed on the lower portion, whenever there is a user input, such that mechanical fatigues are accumulated to damage a touch screen. In addition, the position of the input can be detected only when the upper ITO electrode contacts the lower ITO electrode, such that when there is a soft touch, that is, when a predetermined strength of the input is not applied, it cannot detect whether there is a touch.

In order to solve the problems, more researches on the capacitive touch screen having good touch sensitivity and durability while performing multi-touches has been recently made. In the capacitive touch screen, the ITO electrode formed on the transparent substrate measures the change in capacitance, wherein the ITO electrode becomes an electrode of a capacitor and the transparent substrate becomes dielectrics of the capacitor, thereby detecting parasitic capacitance.

At this time, the control of the sensitivity is important so as to accurately measure the coordinates. If the sensitivity is excessively lowered, it is difficult to sense the touch itself, and if the sensitivity is excessively raised, it is difficult to sense the touch due to noise, such that it is important to set proper sensitivity.

However, although the capacitive touch screen, in which the ITO electrodes do not directly contact each other, can measure the coordinates of the input even in the case of a soft touch, it may erroneously measure the coordinates thereof if parasitic capacitance is generated due to noise. In addition, the sensitivity constantly remains although the user input approaches the touch screen, the coordinates are not accurately measured.

### SUMMARY OF THE INVENTION

The present invention has been made in an effort to provide a touch screen that can accurately measure coordinates by controlling sensitivity based on the change in capacitance according to a user input, and a method for controlling the same.

A touch screen according to a preferred embodiment of the present invention includes: two sheets of transparent substrates; transparent electrodes each formed on one surface of the two sheets of transparent substrates and sensing the change in capacitance at the time of a user input; and a spacer bonding one surface of the two sheets of transparent substrates to each other, wherein the coordinates of the input are measured by detecting the change in capacitance sensed by the transparent electrodes and lowering sensitivity when the capacitance becomes larger.

Herein, the touch screen further includes electrodes each formed on one surface of the two sheets of transparent substrates and applying voltage to the transparent electrodes.

Further, the touch screen further includes a display formed on any one of the two sheets of transparent substrates and displaying an image.

Further, the touch screen measures whether the input is generated by raising the sensitivity when the capacitance sensed by the transparent electrodes becomes smaller.

A method for controlling a touch screen according to a preferred embodiment of the present invention includes: (A) sensing the change in capacitance of the touch screen when there is a user input; (B) measuring coordinates of the input by lowering sensitivity of the touch screen when the sensed capacitance becomes larger; and (C) repeating steps (A) and (B) and measuring the coordinates of the input when the user input contacts the surface of the touch screen.

At this time, the capacitance becomes larger when the user input approaches the surface of the touch screen and icons displayed on the surface of the touch screen that the user input approaches expand when the capacitance becomes larger.

Further, at step (B), when sensed capacitance becomes smaller, the sensitivity of the touch screen is raised to measure whether the input is generated.

### BRIEF DESCRIPTION OF THE DRAWINGS

FIG. 1 is a cross-sectional view of a touch screen according to a preferred embodiment of the present invention;

FIGS. 2A and 2B are cross-sectional views explaining a method for controlling the touch screen of FIG. 1;

FIG. 3 is a flow chart explaining a method for controlling the touch screen of FIG. 1; and

FIG. 4 is a diagram explaining the expansion of an icon according to the control of the touch screen of FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

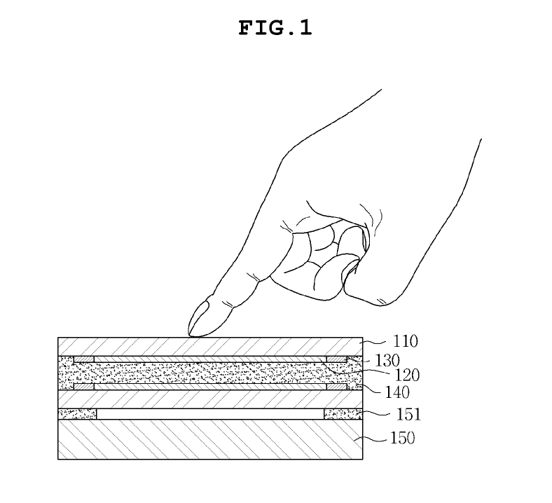

FIG. 1 is a cross-sectional view of a touch screen 100 according to a preferred embodiment of the present invention. Hereinafter, the touch screen 100 according to the present embodiment will be described with reference to FIG. 1.

As shown in FIG. 1, the touch screen 100 according to the present embodiment includes two sheets of transparent substrates 110, transparent electrodes 120, electrodes 130, a spacer 140, and a display 150.

The transparent substrates 110 are a member that provides a space where the transparent electrodes 120 are formed, while protecting the touch screen 100.

Herein, the transparent substrate 110 is a part receiving an input from a user's body or a stylus pen, etc., and preferably made of a material having large durability. Further, the transparent substrate 110 may be made of a transparent material for a user to be able to see an image from the display 150 well, and, for example, may be made of polyethylene terephthalate (PET) or glass.

Meanwhile, it is preferable to apply high-frequency treatment or primer treatment to one side of the transparent substrates 110 to improve the adhesion with the transparent electrodes 120.

The transparent electrode 120 is a member that is formed on one side of the transparent substrate 110 and senses signals input by the user.

Herein, the transparent electrode 120 senses change in capacitance from the input of a specific object, such as the user's body or a stylus pen, and transfers the change to a controller (not shown), and then the controller (not shown) recognizes the coordinates of the pressed position, thereby implementing desired operations. More specifically, when high frequency is diffused throughout the transparent electrodes 120 by applying voltage through the electrodes 130 and then there is contact input by a human body etc., a predetermined change occurs in capacitance while the transparent electrodes 120 function as electrodes and the transparent substrates 110 function as dielectrics, and the controller (not shown) can recognize the contact position or whether there is a contact, by detecting the changed waveform.

Meanwhile, the transparent electrodes 120 may be made of a transparent material for a user to be able to see the display 150 under them, preferably conductive materials. For example, the transparent electrodes 120 may be made of conductive polymer containing poly-3, 4-ethylenedioxythiophene/polystyrenesulfonate (PEDOT/PSS), polyaniline alone or a mixture thereof, or metal oxides, such as indium tin oxide (ITO). Further, the transparent electrode 120 may have various shapes, such as a rod shape, a diamond shape, a hexagonal shape, an octagonal shape, and a triangular shape.

The electrode 130 is a member that is formed on the transparent substrate 110 to apply voltage to the transparent electrode 120.

Herein, the electrode 130 may be made of a material having excellent electrical conductivity so as to supply voltage to the transparent electrode 120. For example, the electrode 130 may be made of a material composed of silver (Ag) paste or organic silver. Further, in order to reduce a bezel area, the electrode 130 may be made of a transparent material, such as a conductive polymer or a metal oxide, similar to the transparent electrode 120.

The spacer 140 insulates transparent electrodes 120 from each other, formed on the transparent substrates 110, respectively, while simultaneously bonding the two sheets of transparent substrates 110. Herein, although the material of the spacer 140 is not specifically limited, it is preferable to use an optical clear adhesive (OCA) having both insulation and adhesiveness.

The display 150, a member that displays images to a user, is bonded to any one of the transparent substrates 110 by an adhesive layer 151.

Herein, the display 150 is an element displaying images for information transmission to the user and displaying reaction when the user touches the touch screen 100, to the user. The display 150 may be, for example, a liquid crystal display device (LCD), a plasma display panel (PDP), an electroluminescence (EL), a cathode ray tube (CRT) or the like.

Meanwhile, although the adhesive layer 151 is shown to be formed on only the outer sides between the transparent substrate 110 and the display 150 in FIG. 1, the present invention is not limited thereto but the adhesive layer 151 may be formed on the entire surface between the transparent substrate 110 and the display 150. At this time, when the adhesive layer 151 is formed on only the outer sides between the transparent substrate 110 and the display 150, for example, a double-sided adhesive tape (DAT) may be used, and when the adhesive layer 151 is formed on the entire surface between the transparent substrate 110 and the display 150, for example, an optical clear adhesive (OCA) may be used.

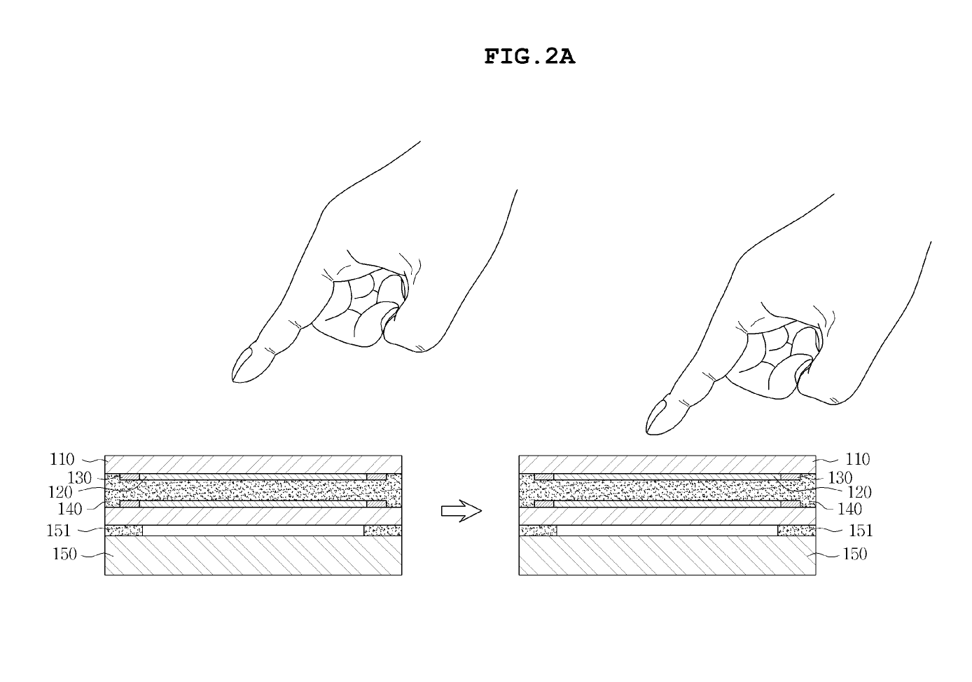

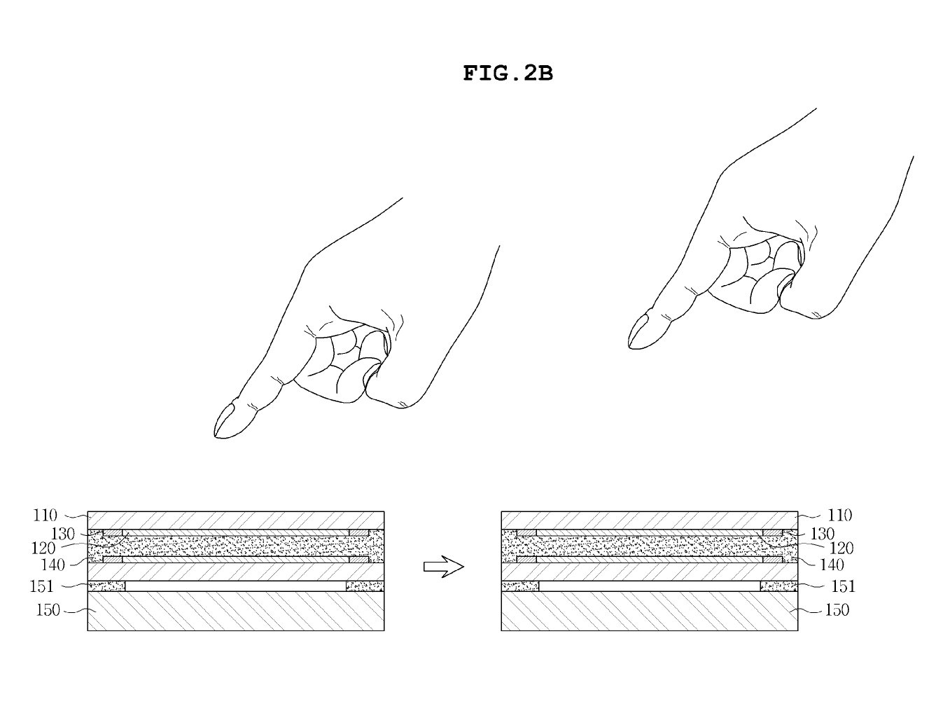

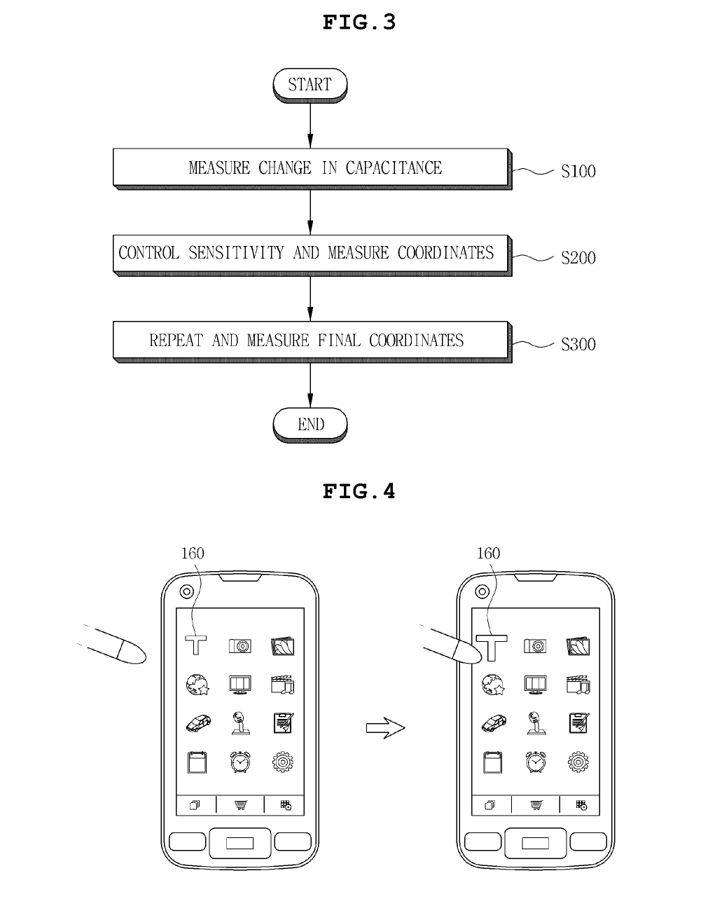

FIGS. 2A and 2B are cross-sectional views explaining a method for controlling the touch screen 100 of FIG. 1, FIG. 3 is a flow chart explaining a method for controlling the touch screen 100 of FIG. 1; and FIG. 4 is a diagram explaining the expansion of an icon 160 according to the control of the touch screen 100 of FIG. 1. Hereinafter, a method for controlling the touch screen 100 of which sensitivity is automatically changed based on the capacitance according to the present embodiment will be described with reference to the drawings.

First, when there is a user input, the transparent electrodes 120 of the touch screen 100 sense the change in capacitance (S100).

At this time, the capacitance can be measured not only when a user contacts the transparent substrates 110 but also when the user approaches them. Further, as the user input approaches the transparent substrates 110 of the touch screen 100, the capacitance becomes larger. The capacitance is represented by C=ε0 A/d and the capacitance C is in inverse proportion to the distance d, such that as the distance d between the user input and the transparent substrate 110 become closer, the capacitance C sensed by the transparent electrode 120 becomes larger.

Next, sensitivity is controlled based on the change in the measured capacitance and coordinates of the input are measured (S200).

At this time, the controller (not shown) can control the sensitivity of the touch screen 100 based on the data of the capacitance measured by the transparent electrode 120. More specifically, if the capacitance becomes large, it means that the user input approaches the touch screen, such that the sensitivity is lowered, and if the capacitance becomes small, it means that the user input is away from the touch screen, such that the sensitivity is raised. Herein, when the sensitivity is lowered, the sensible distance becomes small but the accuracy is improved, whereas when the sensitivity is raised, the sensible distance becomes large but the accuracy may be degraded.

In other words, as shown in FIG. 2A, when the capacitance becomes larger as the user input approaches the touch screen 100, the accuracy is improved by lowering the sensitivity of the touch screen 100, thereby making it possible to distinguish noise from the user input and to clearly grasp the positions of the user input. In addition, as shown in FIG. 2B, when the capacitance becomes smaller as the user input is away from the touch screen 100, it can grasp whether there is a user input by raising the sensitivity of the touch screen 100 so as to increase the sensed distance. At this time, when the sensitivity is high, the accuracy is degraded, such that it can not clearly distinguish noise from the user input, as a result, the coordinates of the input may not be detected.

Meanwhile, as described above, the control of the sensitivity may be processed continuously or processed by step by step based on the change in capacitance. For example, the sensitivity may be 3 when the measured capacitance is 1.0 to 1.5 pF, the sensitivity may be 2 when the measured capacitance is 1.5 to 2.0 pF, and the sensitivity may be 4 when the measured capacitance is 0.5 to 1.0 pF. In this case, the sensitivity maintains 3 until the capacitance changes from 1 pF to 1.5 pF and may be lowered to 2, by one level, at the moment when the capacitance exceeds 1.5 pF.

Next, the step of sensing the change in capacitance and the step of controlling the sensitivity are repeated (S300).

At this time, when the user input approaches the transparent substrate 110 of the touch screen 100 to contact the transparent substrate 110, the coordinates of the user input are finally measured. The capacitance becomes larger as the user input approaches the touch screen and the sensitivity becomes lower as the capacitance becomes larger, such that it is possible to distinguish the user input from noise since the sensitivity becomes lowers, as a result, the coordinates of the user input can be clearly measured.

Meanwhile, as shown in FIG. 4, the display 150 is installed under the touch screen 100 and images from the display 150 can be changed depending on the control of the sensitivity of the touch screen 100.

More specifically, a controller (not shown) can be constituted to lower the sensitivity when the user input approaches the transparent substrate 110 of the touch screen 100 and to expand icons 160 displayed on the display 150 as the sensitivity becomes lower. In general, the icons 160 displayed on the touch screen 100 are displayed to be small due to space limitations. When the icons 160 expand as the user input approaches the touch screen, it can provide convenience in accurately touching the icons 160.

According to the touch screen and the method for controlling the same according to the present invention, when the capacitance measured as the user input approaches becomes larger, noise is distinguished from the user input by lowering the sensitivity, thereby making it possible to accurately measure the coordinates of the input.

In addition, according to the present invention, when the capacitance becomes smaller as the input user is away from the touch screen, the sensed distance is lengthened by raising the sensitivity, thereby making it possible to grasp whether there is a user input.

In addition, according to the present invention, although the icons displayed on the display are small, the sensitivity is lowered and the icons expand as the user input approaches the touch screen, thereby making it possible to provide convenience for the user in touching the icons.

Although the preferred embodiments of the present invention have been disclosed for illustrative purposes, they are for specifically explaining the present invention and thus the touch screen and the method for controlling the same according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen, comprising:
two sheets of transparent substrates;
transparent electrodes each formed on one surface of the two sheets of transparent substrates and sensing the change in capacitance at the time of a user input; and
a spacer bonding one surface of the two sheets of transparent substrates to each other,
wherein the coordinates of the input are measured by detecting the change in capacitance sensed by the transparent electrodes and lowering sensitivity when the capacitance becomes larger.

2. The touch screen as set forth in claim 1, further comprising electrodes each formed on one surface of the two sheets of transparent substrates and applying voltage to the transparent electrodes.

3. The touch screen as set forth in claim 1, further comprising a display formed on any one of the two sheets of transparent substrates and displaying an image.

4. The touch screen as set forth in claim 1, wherein the touch screen measures whether the input is generated by raising the sensitivity when the capacitance sensed by the transparent electrodes becomes smaller.

5. A method for controlling a capacitive touch screen, comprising:
(A) sensing the change in capacitance of the touch screen when there is a user input;
(B) measuring coordinates of the input by lowering sensitivity of the touch screen when the sensed capacitance becomes larger; and
(C) repeating steps (A) and (B) and measuring the coordinates of the input when the user input contacts the surface of the touch screen.

6. The method for controlling a capacitive touch screen as set forth in claim 5, wherein the capacitance becomes larger when the user input approaches the surface of the touch screen and icons displayed on the surface of the touch screen that the user input approaches expand when the capacitance becomes larger.

7. The method for controlling a capacitive touch screen as set forth in claim 5, wherein at step (B), when sensed capacitance becomes smaller, the sensitivity of the touch screen is raised to measure whether the input is generated.
